(19) United States
(12) Patent Application Publication
(10) Pub. No.: US 2002/0103694 A1
(43) Pub. Date: Aug. 1, 2002

(54) Integrated IVR/WEB data gathering process and method

(76) Inventor: Paul Frazier, Omaha, NE (US)

Correspondence Address: Shughart Thomson & Kilroy, P.C., Twelve Wyandotte Plaza, 120 West 12th Street, Kansas City, MI, 64105, US

(21) Appl. No.: 09/773,085

(22) Filed: Jan. 31, 2001

(51) Int. Cl. G06F 17/60

(52) U.S. Cl. 705/11; 705/7

(57) ABSTRACT

A method of gathering data uses both a telephone channel and an Internet channel to forward data to a single data bank. The method also includes steps of checking for duplicate data entries and verifying the accuracy of some of the data input. Certain responses are identified for special handling and all respondents are notified of the action taken with respect to their response.

### BACKGROUND OF THE INVENTION

In the past, millions of people have purchased goods and services via the telephone and/or the mail. Many companies use this process of purchasing goods and services to obtain and gather important information regarding purchasing habits and tendencies as well as valuable customer profiles. Many times, these data are obtained via promotions and/or give-away campaigns which encourage responses from potential customers. A respondent is asked a series of questions in order to obtain a gift or the like. This data is then analyzed and mined by the company.

Current estimates are that nearly eighty million Americans and Canadians as well as millions more internationally are Internet users, with an estimated twenty million using the Internet to purchase products and services. The number of Internet users is projected to grow to more than two hundred fifty million in the near future. It would be advantageous to companies to be able to obtain, analyze and mine data obtained via Internet responses in the same manner as has data from telephone and/or mail campaigns.

However, in order to conduct the most efficient data-gathering campaign possible, it would be most advantageous to collect data from a plurality of sources. This would leave the choice of response to the respondent. This, in and of itself, would encourage response.

However, in the past, if data is gathered using a variety of response choices, these data must be collected from the individual channels and then combined into a common data base for analysis. Often, this combination has ben carried out manually. This is a time-consuming and possibly error containing method.

Therefore, there is a need for a method of gathering data from a plurality of different sources which can efficiently and accurately combine the data so gathered into a common data base.

Still further, each separate process may be subject to its own errors, rules and/or limitations. These errors and limitations must be handled separately which presents significant drawbacks to conducting the most efficient data gathering campaign.

Therefore, the is a need for a data-gathering process which permits a respondent to select from a number of different response methods with all responses, regardless of the chosen response method, being automatically routed to a single data base whereby the drawbacks and disadvantages associated with separately gathering responses from different response methods are avoided.

Still further, there may be special rules and requirements imposed on any specific data gathering process. An example of this is a requirement that duplicate responses be rejected so that a respondent is counted only once in the data gathering process. This may be very difficult to accomplish if separate data-gathering techniques are used and not coordinated. Therefore, there is a need for a data-gathering process which can utilize several different methods of data gathering yet which can also impose special requirements on each channel of data gathering.

Still further, some data-gathering programs may have a requirement to customize certain data. This may be inefficient if several different modes of data gathering are used. Therefore, there is a need for a method of gathering data which can accept data from several sources yet which can customize gathered data as necessary and required.

### SUMMARY OF THE INVENTION

The herein-discussed disadvantages and drawbacks are overcome by a single data-gathering process in which responses gathered from a plurality of different methods, including telephone and Internet responses, are automatically combined into a single data bank. Data from the single data bank can then be analyzed whereby the broadest possible data universe is obtained. Errors and difficulties are minimized because of the overall unitary process. Still further, uniform data gathering techniques and criteria can be applied to all gathered data thereby eliminating errors associated with non-uniformity in data gathering techniques and criteria.

Still further, data processing and analysis can be as automated as possible by, as much as possible, eliminating manual inputs and manual steps in the overall data gathering process.

Still further, any processing or customizing of data can be easily implemented by the data-gathering entity whereby a respondent is not required to change his or her entered data. The less burdensome the data entry is, the more likely the respondent is to supply the requested data.

### TECHNICAL FIELD OF THE INVENTION

The present invention relates to the general art of data processing, and to the particular field of methods of data gathering.

### OBJECTS AND ADVANTAGES OF THE INVENTION

It is a main object of the present invention to make data gathering on consumers as efficient and as effective as possible.

It is another object of the present invention to automatically integrate telephone and Internet responses into a single data bank.

It is another object of the present invention to impose special requirements on a data gathering process in the most expeditious manner.

It is another object of the present invention to control duplicate entries in the most efficient and effective manner possible in a data gathering process.

It is another object of the present invention to make data processing as efficient as possible in a multi-channel data gathering process.

It is another object of the present invention to permit customization of data in a data gathering process as efficient as possible.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof

### BRIEF DESCRIPTION OF THE DRAWINGS

FIG. 1 is schematic showing a flow diagram of the prior art method of gathering data from a plurality of sources.

FIG. 2 is a schematic showing a flow diagram of the overall method embodying the present invention.

FIG. 3 is a more detailed schematic showing a flow diagram of the overall concept of the present invention.

FIG. 4 is a schematic showing a flow diagram of a form of the present invention.

FIG. 5 is a schematic showing a flow diagram of another form of the present invention.

FIG. 6 is a schematic showing a flow diagram of another form of the present invention.

FIG. 7 is a more detailed schematic showing a flow diagram of the present invention.

FIG. 8 is a schematic showing a flow diagram of a specific embodiment using an Internet entry method of the present invention.

FIG. 9 is a schematic showing a flow diagram of a specific embodiment using a telephone entry method of the present invention

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

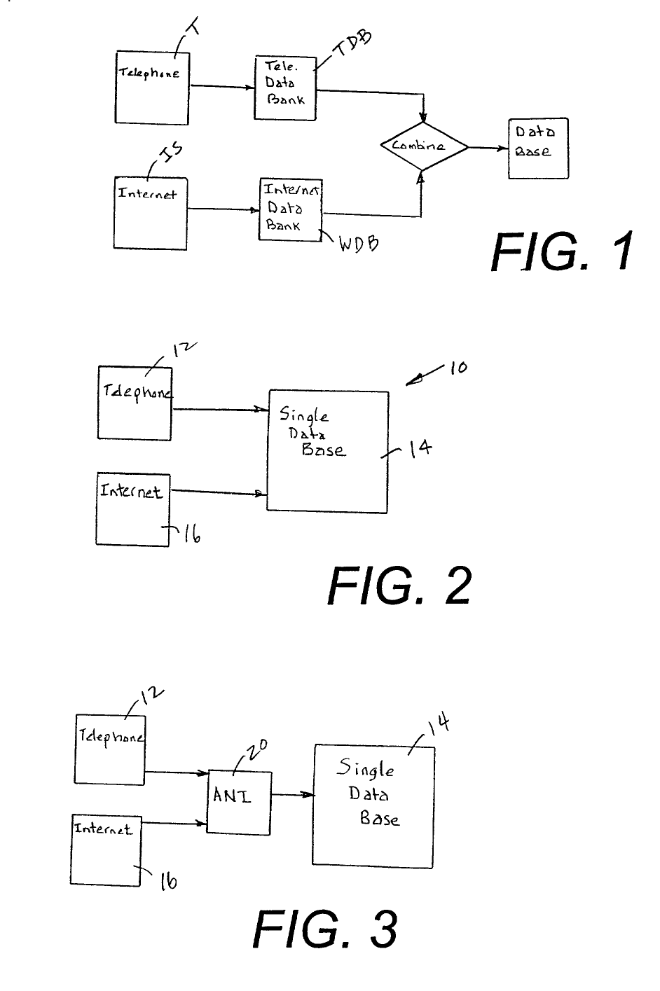

Referring first to FIG. 1, a data gathering process embodying the prior art can be seen to include a telephone channel T in which a respondent calls a telephone number, such as a toll-free number, in response to an invitation, such as a give-away campaign. The telephone call is coupled to an Interactive Voice Response (IVR) system in which a voice is recognized and further steps in an automated process are taken or a human operator is notified as necessary. In any event, the call is routed to an appropriate telephone data TDB for storing the data obtained from the telephone call. As discussed above, this telephone call can be via a toll-free number or the like.

Still further, as discussed above, since so many people are using the Internet, it is often desirable to gather data using the Internet. In the Internet channel, a user will enter the channel via a screen IS or the like and enter data in a manner similar to the above-described telephone channel. The data from the user, including so-called “cookies” can be gathered and forwarded to a web data base WDB in a manner known to those skilled in the art.

Data from web data base WDB is then collected and combined with data from telephone data base DB for further processing by a user. This collection and combination is often carried out manually. As discussed above, data in this manner can be error prone and inefficient. Accordingly, the present invention seeks to avoid the extra steps of manually combining data from a telephone channel with an Internet channel by automatically combining and processing these data channels.

This is indicated in FIG. 2 in which an overall system 10 collects data from a telephone channel 12 directly into a single data bank 14 along with data from an Internet channel 16 which is also fed directly to single data base 14.

As shown in FIG. 3, one form of the system 10 includes a step 20 of assigning an Automated Number Identification (ANI) which automatically assigns a number to the call whether the call enters via a telephone channel or via an Internet channel before forwarding the call on to the single data base 14. It is also noted that data base 14 can be any storage well known to those skilled in the art. The particular form of the data base is not part of the present invention and thus will not be discussed. Still further, the methods used to store data and to retrieve data from the various data bases that can form data base 14 are not part of the present invention and thus will not be discussed in detail as one skilled in the data storage and retrieval arts will be able to design appropriate routines and hardware based on the teaching of the present disclosure.

As discussed above, the accuracy of some data analysis projects will be undermined if duplicate entries are made for the same data. For example, if a company wishes to determine where potential customers are for advertising or marketing purposes, that company may wish to determine how many people in a particular zip code are interested in its products. However, if multiple data entries from a single input are permitted, the data may be skewed. Therefore, the company may wish to exclude duplicate data entries from the universe of data being analyzed. Accordingly, prevention and/or rejection of duplicate entries for what should be a single data point is often desired in a data gathering process.

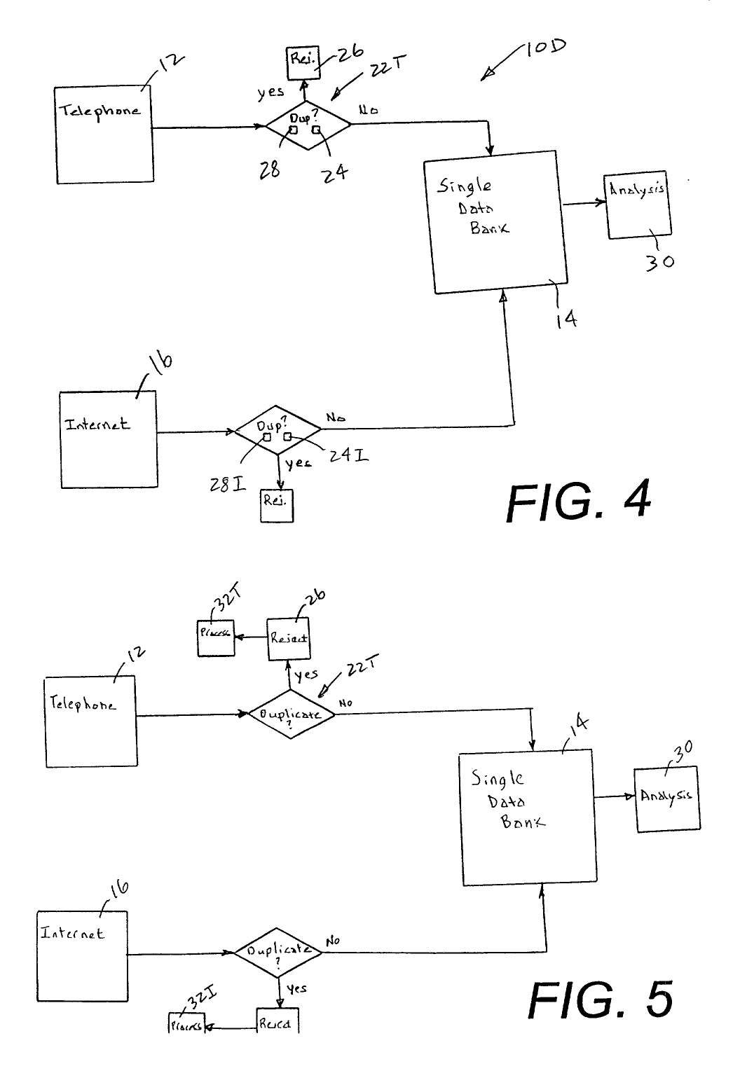

This process is indicated in FIG. 4 in which a routine 22T is inserted for a telephone channel and a routine 22W is inserted for an Internet channel of the integrated process 10D to prevent duplicate data from being entered into the data base 14 which receives data from both a telephone channel and from an Internet channel as discussed above. Each data entry from the telephone channel or from the Internet channel can be tagged in a manner known to those skilled in the art so that data entry will be identified in a manner that identifies the entry port. Those familiar with telephone and/or Internet procedures will understand how such tagging can be effected, such as by caller identification for the telephone channel and by cookies from the Internet channel, or the like.

Subroutines 22T and 22I are similar and thus, only routine 22T will be discussed it being understood that routine 22I is identical to routine 22T. Routine 22T receives a call that is identified from the telephone channel. The call is analyzed for its identification and checked against calls stored in a data bank 24. If the incoming call is matched to a call stored in data bank 24, the call is rejected via route 26. Route 26 can include a telephone message that is relayed to the caller that the call is a duplicate and the caller is thanked, but the call will not be further processed, or the like. Routine 22T can also include a subroutine 28 that will permit certain duplicate entries while rejecting others. For example, subroutine 28 can be programmed to accept four calls from a single telephone, or the like. Subroutine can also be time based, in that it can be programmed to accept one call per week from a single telephone, or the like before sending the call to the reject routine. Subroutine 22T can also be programmed to keep track of duplicate entries as even this data may be of some value. Thus, the term “duplicate” will be defined according to the needs of the designer to include not merely double calls, but calls that meet the criteria set up for rejecting data that may undermine the overall analysis being conducted using system 10D.

Routine 22T is programmed to pass on all data that are not rejected as being duplicate to data base 14 for appropriate analysis in step 30 including a step of merging telephone responses and Internet responses into a single merged data report.

As discussed above, even duplicate entries can be of use in appropriate situations. Accordingly, system 10P shown in FIG. 5 will process duplicate entries using process steps 32T and 32I. For example, process step 32T may be a simple telephone message thanking the caller and providing instructions on when and how to call again. Process step 32T can record the duplicate entry and transfer this information to data bank 14 in a manner that can be used in an analysis step 30, or simply deleted or the like. Process 32I can include a screen message corresponding to the call information just discussed for step 32T.

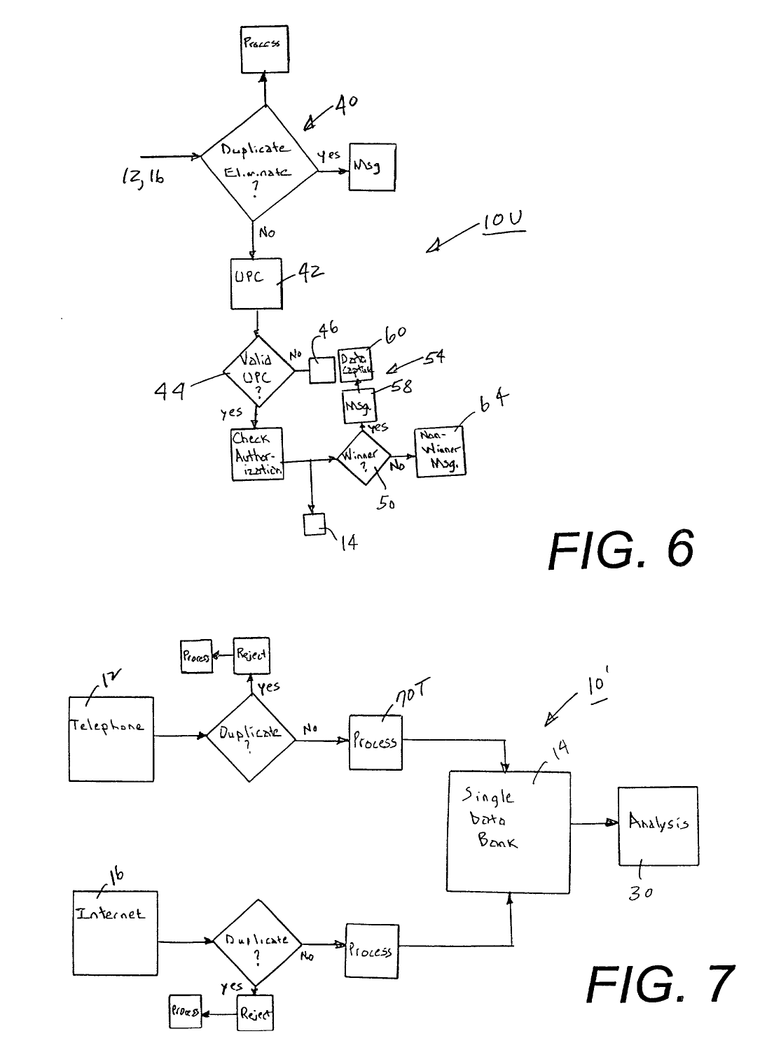

Some data gathering programs require purchasing of an item. Often, these items include Uniform Product Codes (UPC). The data analysis of such patterns can use UPC as a data point. Such a program is indicated in FIG. 6 as system 10U which includes a UPC routine 40 associated with both the telephone entry channel 12 and the Internet entry channel 16. Since the routine 40 will be similar for each entry channel, only one routine will be described, it being understood that one skilled in the art can make appropriate modifications to the routine for telephone data and for Internet data based on the teaching of this disclosure.

Routine 40 includes a duplicate elimination routine such as described above. If the data entered is a duplicate, it is sent to the appropriate routines as discussed above. If the data entered is not a duplicate, it is forwarded for further processing. At this point, the UPC code can be entered in step 42 either by telephone (voice or touch tone (tt) entry) or via inputs to an Internet screen or the like. The validity of the UPC is checked in step 44. If the UPC is incorrect, then the data entry is forwarded to another step 46 for further processing, which can include a message to try again, or a simple rejection as being invalid. If the UPC is valid, the data entry is forwarded on for further processing. FIG. 6 shows one form of the further processing in which a data entry is checked to determine special handling. One other aspect of the further processing can simply be forwarding the data on to data bank 14 if desired. However, in the interest of completeness, the further processing shown in FIG. 6 is a give-away program that is often used by companies to encourage data entry by consumers, customers or other members of the public. Those skilled in the art of data gathering will be able to design further routines based on the teaching of the present disclosure without departing from the scope of the present disclosure.

If a give-away program is being carried out, the UPC is checked in routine 50 to determine if the particular UPC has been identified in a data bank 52 for special attention (such as a prize or the like), i.e., a “winner.” If the UPC is determined as being a “winner” a further routine 54 is activated to notify the person submitting the data via a special message 58 and to obtain data necessary to complete the give-away via process step 60. On the other hand, if the UPC is identified as not being a “winner,” the data entry is forwarded to routine 64 in which the data entrant is notified that the entry is not a winner. The entrant can be notified to try again, or the like via an appropriate message on the telephone if the entry was via the telephone channel or via a screen message if the entry is via an Internet screen.

As will be understood by those skilled in the art, the various routines and processes disclosed herein can be combined and incorporated as desired. This is indicated in FIG. 7 with system 10′ having a process step 70T and 70I interposed between the duplicate identification steps for each channel of data entry to single data bank 14. The process steps 70T and 70I can include the above-mentioned “winner” identification, relaying programmed messages, comparing UPC, forwarding the data to other routines for special analysis, or the like. Once the data is stored in single data bank 14, it can be analyzed as desired as indicated by step 30.

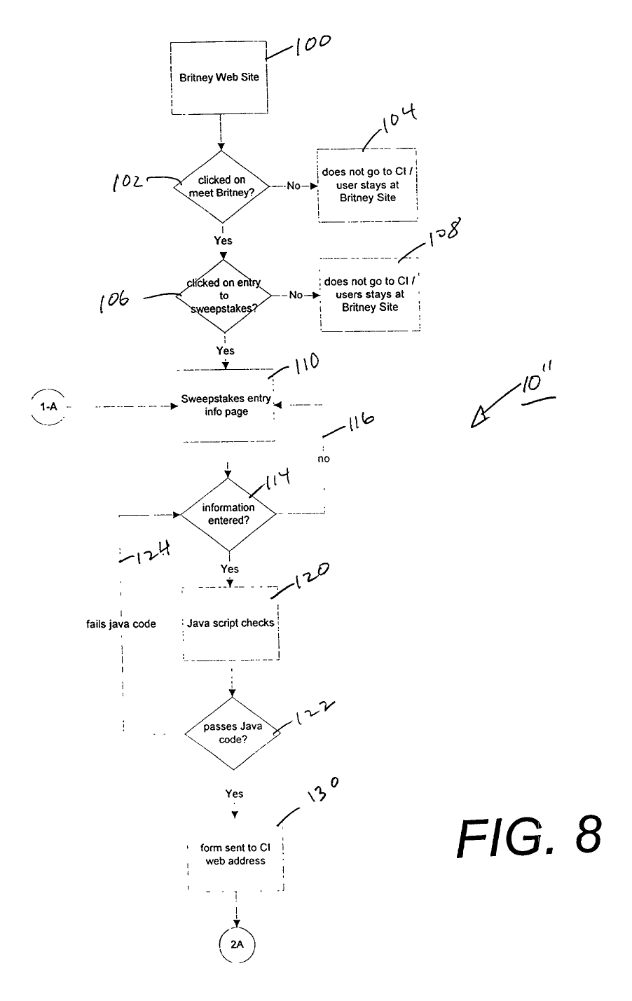

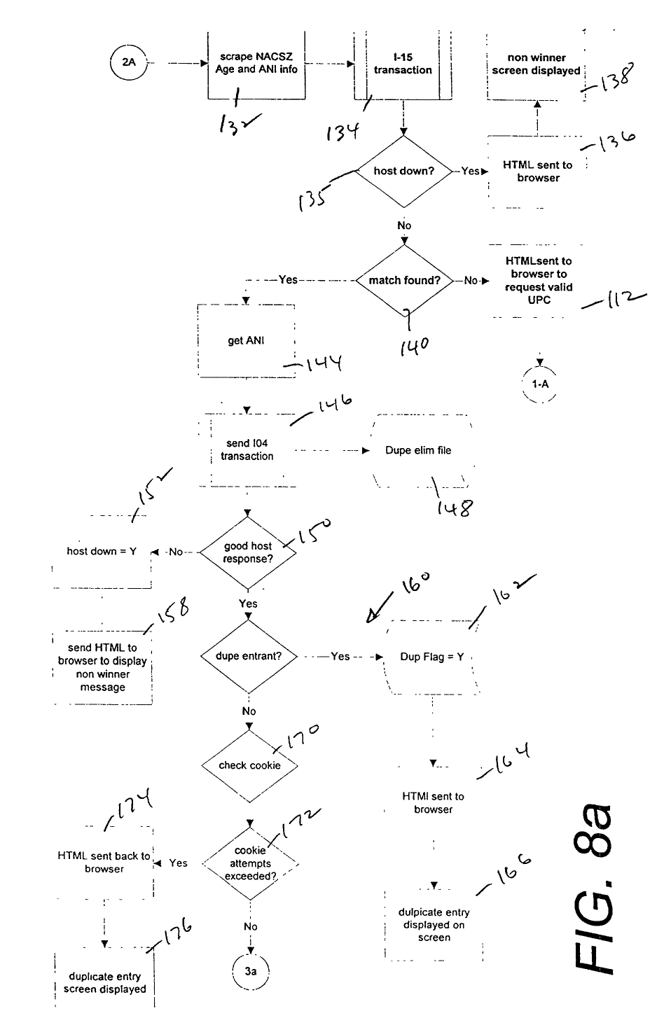

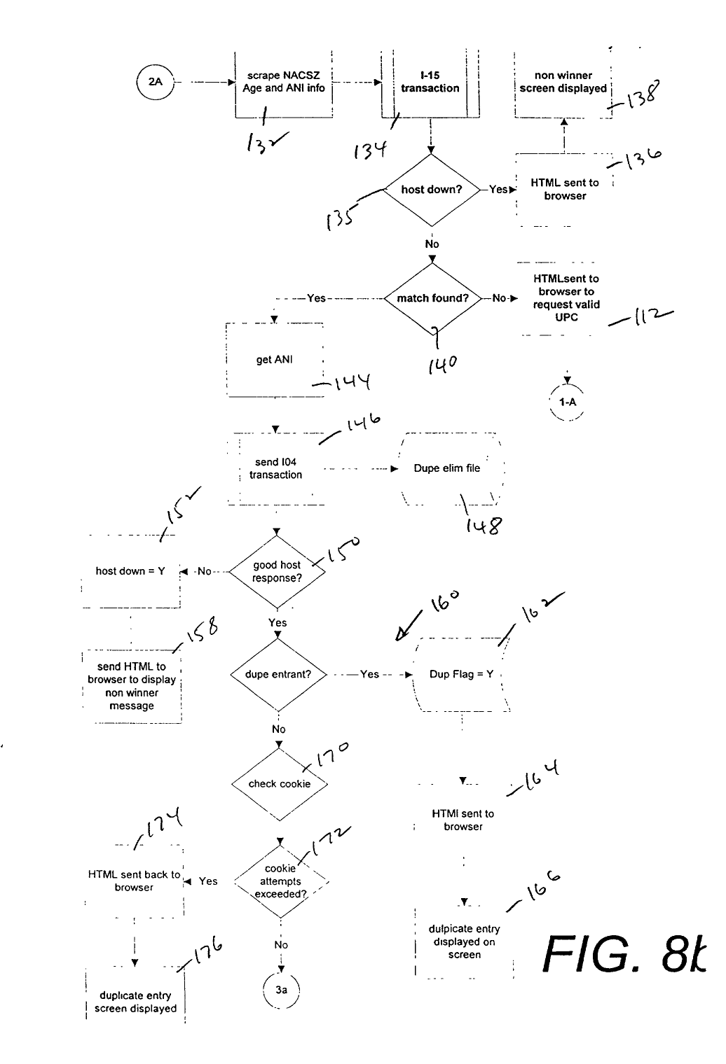

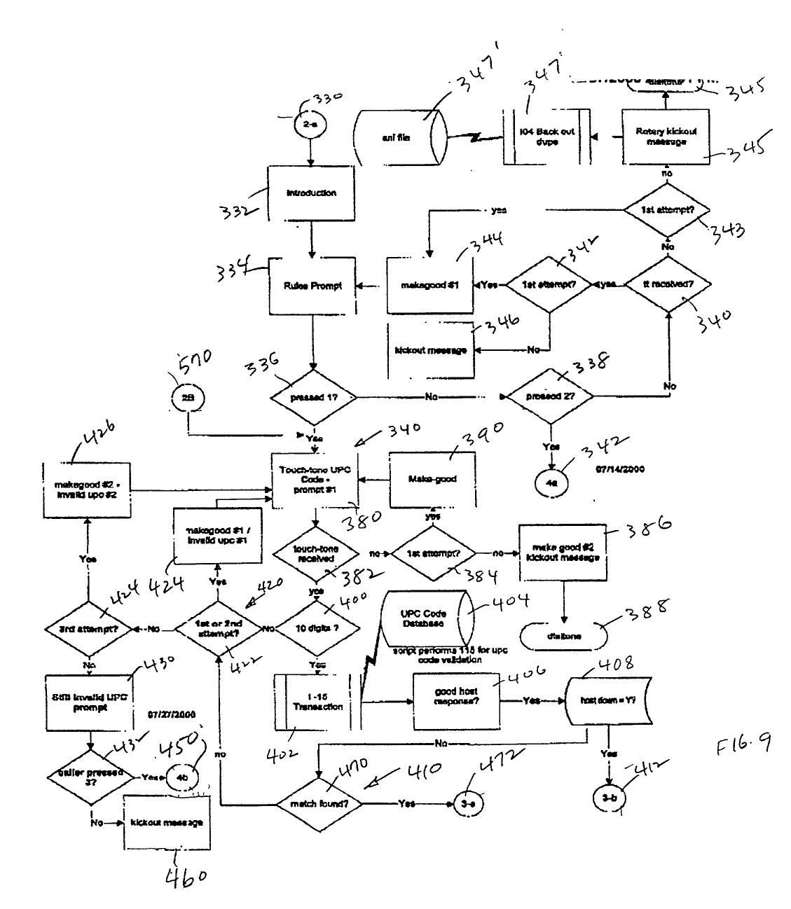

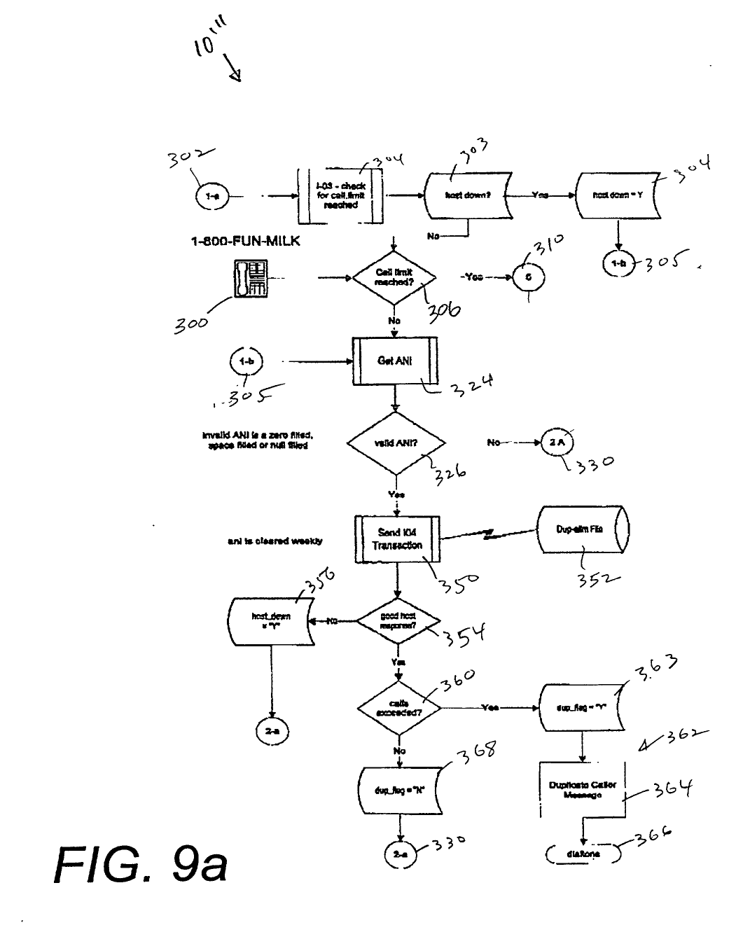

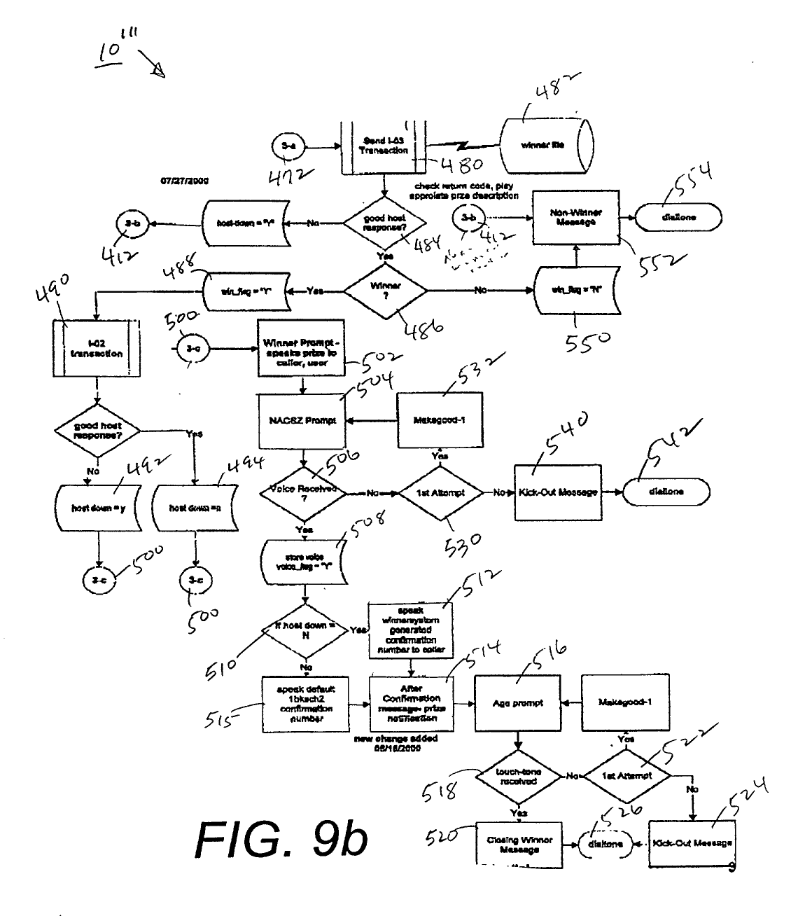

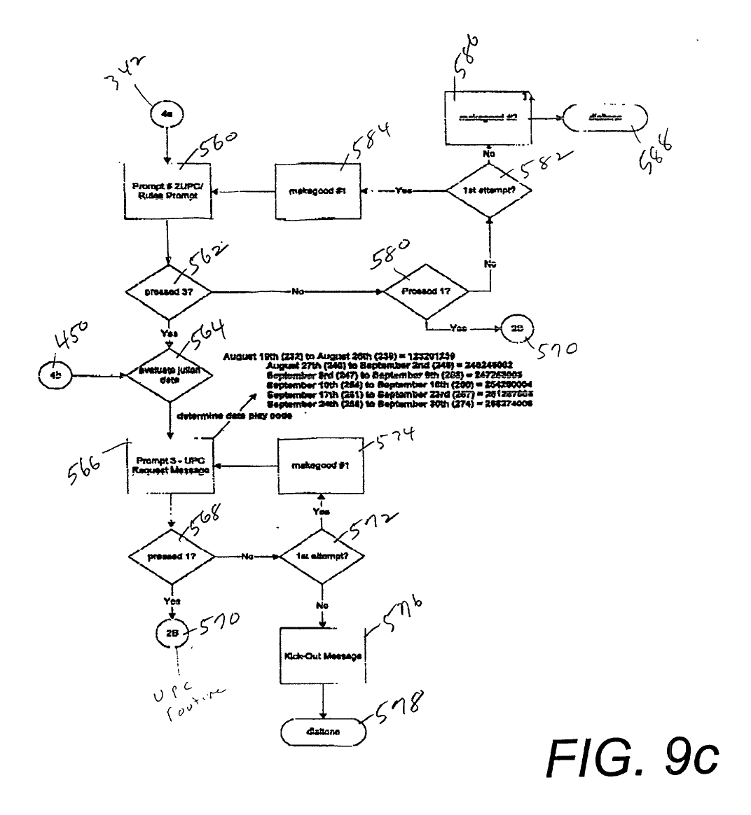

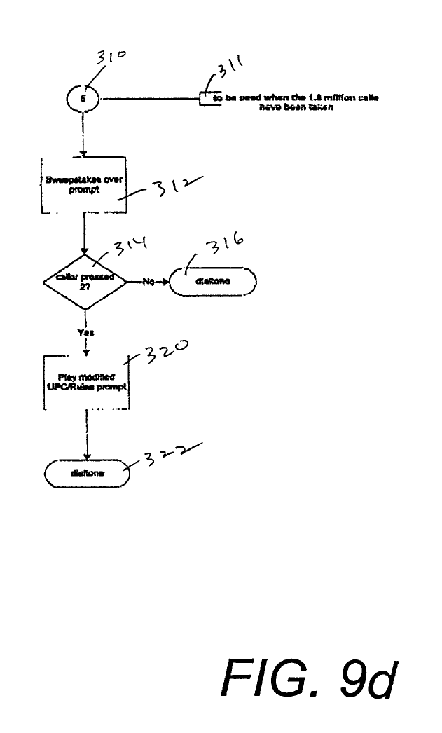

A best mode embodiment of the above-discussed system of data gathering is shown in FIGS. 8 and 9. Since the above descriptions have been directed to a telephone channel, the FIG. 8 system will be directed to an Internet entry channel and will be discussed first. As shown in FIG. 8, system 10″ invites responses using a special campaign associated with Britney Speers. Such a campaign can include prize give aways such as posters, merchandise or the like. As can be seen, entry into system 10″ is via a Britney web site 100 by clicking onto a special icon 102 displayed on the web site. If the icon is not clicked, the system is not activated as indicated in process step 104. However, if the icon is clicked, an entry sweepstakes notice is displayed, and if the respondent wishes to enter a sweepstakes for a give-away, the respondent so indicates at step 106. If the respondent changes his or her mind and wishes to withdraw, this is indicated and process step 108 is activated to return the respondent to the basic web page. However, if the respondent wishes to continue, the “yes” switch is activated, and an entry page is displayed at step 110. The entry page includes information requests as required from UPC validation step 112 as well as other information that may be desired by the data gatherer per step 114. If the respondent does not complete the required information, before trying to move on, the respondent is returned to the basic entry page via path 116; however, if the respondent has supplied the requested information, the next steps of Java script checking is carried out, per step 120. Once the Java script has checked, the Java code is checked in step 126. If the Java code does not check, the respondent is returned to the information entry request step 114 via path 124. If the Java code checks, the respondent's completed entry (from step 110) is forwarded to the data gathering entity CI in step 130.

At the data gathering entity, the respondent's data entry is processed as indicated in steps 132, 134 and 135. If the data gathering entity is not operating, the appropriate data entry is forwarded to an appropriate step 136 and the respondent is notified, in this case by step 138 that the entry was a non-winner. On the other hand, if the data entry is to be passed on, it is forwarded to a matching step 140 to determine if the respondent qualifies for special handling, i.e., a “winner.” This is carried out using stored data and the like as is well known to those skilled in the art. If a match is not found, the respondent is forwarded back to step 112 as indicated in FIG. 8. However, if a match is found, i.e., the respondent is a “winner,” the data entry is sent on to step 144 to extract the ANI and send on appropriate transactional information in step 146. At this point, the duplicate routines can be used as indicated in step 148 to eliminate entries that are defined as being “dupicate” or that are not desired by the data gathering entity.

Further processing includes host evaluation steps 150 and 152 in which the respondent is notified and appropriate data is extracted in step 158 or the data entry is sent to a duplicate routine 160. If the data entry is found to be a duplicate, the dataentry is flagged at step 162, a browser receives data at 164 and the respondent is notified that the data was considered as being a duplicate in step 166. Other actions can also be taken as discussed above.

On the other hand, if the data entry is new (i.e., not a “duplicate”), the cookie is checked in step 170 and the number of cookie attempts checked in step 172. Similar criteria as discussed above in relation to “duplicates” can be used in this step as well. If the check determines that the number of attempts has been exceeded, the appropriate steps 174 and 176 are carried out to extract appropriate information and to display a particular message to the respondent respectively. On the other hand, if this step is passed, the data entry is forwarded on to a “winner” routine 180.

The “winner” routine 180 includes another duplicate check at step 182 and forwarding the data to appropriate data analysis steps, such as step 184 for winner file input from a data bank 186. Host response routine steps 188 and 190 are taken and a non-winner screen is displayed in step 192 if appropriate. On the other hand, if the respondent has been determined as not being a “winner” in step 194, the process steps 196 and 198 are executed before so notifying the respondent in step 200. If, however, the respondent is determined as being a “winner” in step 194, the data entry is flagged in step 202, and appropriate data steps are carried out, such as step 204 and a check to determine if the host is operating is taken in step 206. If the host is not operating, the HTML is sent back to the browser in step 208 and a winner screen is displayed in step 210. On the other hand, if the host is operating, HTML data is extracted and sent to the browser in step 214 and another winner screen is displayed in step 216.

Data so obtained are sent to a single data bank as described above.

A telephone channel is illustrated in FIG. 9 and attention is directed thereto. As indicated in FIG. 3, once the ANI has been established, the data is stored in a single data base or data bank no matter which method is used to enter the system, either telephone entry or Internet entry. Therefore, the steps indicated as boxes 20 and 14 in FIG. 3 are common to both the methods shown in FIGS. 8 and 9. Also, while telephone entry and Internet entry are indicated, other forms of entry can also be accomplished using the process disclosed and taught in this disclosure.

Referring specifically to FIG. 9, it is seen that telephone entry system 10′″ can be begun from either a telephone 300 or from another means 302 via steps 303 and 304, with step 304 providing entry as indicated at point 305 if the host is operating and step 303 not answering if the host is not operating. Whichever entry means is used, the first step is to check to determine if a limit imposed by the data gathering entity has been reached, step 306. That is, the data gathering entity may place a limit on the number of data entries tht it wishes to consider, see box 311. In the specific example being discused with regard to FIGS. 8 and 9, the best mode limit is 1.8 million data entries; however, this number could be any value desired. Once this number of data entries has been reached, the call is routed to a kickout routine 310 which includes a step of notifying the caller that the promotion is over and provides the caller with an option of entering another promotion, boxes 312 and 314. If the caller has exercised the option not to enter the alternative promotion, the system hangs up, box 316. However, if the caller chooses to enter the alternative promotion, a modified process, box 320 is executed. This modified process can include further data gathering steps, or the like as will occur to those skilled in the art based on the teaching of this disclosure, with the data gathered in the alternative process being stored in data base 14 in the manner discussed herein. After completion of the alternative data gathering process, i.e., alternative promotion, the system hangs up, box 322.

If the number of data entries has not been exceeded, and the system is still accepting data entry, the ANI is obtained in step 324 and the validity thereof is checked in step 326. An invalid valid ANI causes the call to be routed to an information providing routine, step 330, which prompts the caller to re-enter the data requested and may provide information on how to enter valid data. Information providing routine 330 includes an introduction step 332 notifying the caller that incorrect information has been provided and letting the caller know that information to help correct the data entry will be provided. Part of this information provision is indicated in boxes 334 and 336 and will be a reiteration of any rules that may apply to a contest or a giveaway promotion, or the like and a request to press a specific key on the telephone to indicate that the caller is ready to move on to the next step. If the caller understands the information thus provided and presses one of the valid options available, boxes 336 and 338, he or she will respond correctly and will be permitted to continue the process. On the other hand, if the caller does not respond in a permitted manner, the process includes a step 340 which determines if the data entered by the caller is properly received, if the data is properly received, the procedure determines if the caller has attempted to enter the data before, step 342. If previous attempts have been made, the caller is routed back to a discussion of the rules for data entry, boxes 344 and 334. If this is a further attempt, i.t., a multiple attempt, the caller is routed to a kickout message 346.

On the other hand, if the caller correctly responds to the prompts made available in step 334, the call will be routed to the appropriate routine, either a data gathering routine for gathering UPC information step or a special data gathering routine, step, which can be of the data gathering entity's choice, step 342. The UPC data gathering routine 342 will be discussed in greater detail below.

If, at step 334, the caller selects an alternate path via step 338, the call can be routed to special step 342 or to step 340, with step 340 determining if the caller's choice was properly received. If not, it is first determined if this is a first attempt or a multiple attempt that exceeds the number of attempts permitted at step 343. If it is the first attempt, the caller is asked to reenter the choice via step 344. If it is a multiple attempt, the call is routed to a kickout message, step 345 which then hangs up at step 345′ and enters appropriate data into duplicate file 347 for access by the ANI files 347′.

Returning to the basic entry routines, once the ANI has been validated in step 326, the data is forwarded to the data bank in step 350, with duplicate data entries identified and eliminated in step 352 in a manner that is similar to the duplicate data identification and elimiation process described above with regard to the Internet entry process, step 146 in FIG. 8. Once ANI data entry has been completed, host testing is carried out in steps 354. If the host is not accepting data, the call is routed to the above-discussed information prompt routine 330. However, if the call is to be further processed, the process checks to determine if the total number of data entries desired by the data gathering entity has been exceeded as discussed above, step 360. If the data gathering entity does not need any more data, the call is routed to a hangup routine 362 where duplicate calls are identified in steps 363 and 364 and the call is terminated in step 366. On the other hand, if the number of data entries has not been exceeded, the call is forwarded on to a duplicate data entry check step 368 and then on to information prompt routine 330.

Returning to the rules prompt step, step 334, if the caller elects to enter one of the process, in this case, the UPC data gathering process 340, the caller signifies by pressing an appropriate number on the telephone. As can be seen in FIG. 9, the caller can elect to enter the UPC data gathering process after being informed of the rules in the special routine 342. The call is then routed to UPC data gathering process 340 at step 380. The system determines if the signal has been properly received at step 382. If the tone is not properly received, the system determines if the caller has attempted to enter the requested tone before at step 384. If the caller has not attempted to enter the tone before, the caller is asked to again enter the requested tone at step 386. If the caller again enters the incorrect tone, the system hangs up at step 388. On the other nand, if the caller has not previously tried and failed to enter the requested tone, the system asks the caller to re-try at step 390 which then reroutes the call back to step 380.

Once the proper tone is entered, the call is routed to a step 400 which checks the number of digits entered in the data entry step 380. If the digits are one form, for example, ten digits, the call is routed to the next step, step 402 to check the entered data against a data bank 404 to determine if the enry is to be given special treatment, such as being identified as a “winner” for a give-away campaign conducted to gather data. If the call is identified as being selected for special treatment at steps 406 and 408, it is forwared on to a special handling routine 410. On the other hand, if the call is not selected for special handling, it is forwarded to a non-special handling routine, identified in FIG. 9 as non-winner routine 412. Non-winner routine 412 will be discussed in greater detail below as will winner check routine 410.

Returning to step 400 in which the number of tones are determined, if the number of data entry tones is less than the amount determined by the data gathering entity as being proper, the call is routed to digit check routine 420 in which the call attempt number is checked in step 422. If the number of call attempts is less than that number determined by the data gathering entity as being permittted, in this case, two, the call is returned to the initial entry step 380 via a checking step 424. On the other hand, if the call attempt has exceeded the maximum permitted number, the call is routed to step 424 which makes another check on the data entry attempt number. If the data attempt number exceeds the permitted number for this last chance, the call will be routed to step 426 which will inform the caller of further instructions as necessary, or return the call to step 380 for another attempt at proper data entry, or will drop the call if suitable. On the other hand, if the data entry is still less than the number permitted, this “last chance” check, the call will be routed to an invalid data entry prompt, step 430 in which further instructions for proper data entry are provided. The call is checked at step 432 to determine if the caller has selected another prompt. If the caller selects the alternative prompt, the call is routed to a repeated information routine 450 which will be discussed below. On the other hand, if the caller does not select the alternative path, and has exceeded the number of permitted attempts at data entry, the call is routed to a kickout routine 460 which will be discussed in greater detail below.

Returning to steps 406 and 408, if the call is identified as being proper for special handling, the call is matched to data base 404 and if a match is found in step 470, the call is routed to a special handling routine, identified in FIG. 9 as a winner check routine 472 which will be discussed below. If a match is not found, the call is routed back to step 422 which checks to dtermine if the call is an attempt at a duplicate data entry. If the call is not an attempt at a duplicate entry, then the call is routed back to step 400. If the call is an attempt at a duplicate data entry, the call is routed to step 424 for return to the above-discussed routine.

With regard to the winner check routine 410, the call is routed from step 470 to a transaction forwarding step 480 which checks the call against a data base 482 to determine if the call is subject to special handling, i.e., the entry is a “winner” for a give-away campaign. If the host response is proper in step 484, the call is checked to determine if it is a “winner” in step 486. If the call is a “winner,” the call is flagged at step 488, the transaction recorded in step 490, and checked again in step 492. If the call passes the step 490 check, it is routed to step 492 or to step 494 as appropriate, and then on to the winner selected routine 500. In routine 500, a winner prompt step is carried out at steps 502 and 504. If the prompt is returned at step 506, voice data is stored at step 508 and a host check is performed at step 510. If the host is down, the call is forwarded to step 512 in which spoken information is exchanged. After completion of step 512, confirmation of information is carried out in step 514, and further information is requested in step 516, such as age or the like. If the host is not down, the call is forwarded via a default step 515 to the step 514. After the further information is received, a check is made of the entry method in step 518. If the check is passed, the winner is so notified in step 520. However, if the check in step 518 is not passed, the caller is asked to reenter the information and the attempt number is checked in step 522 and the caller is given another chance to enter the requested information. If the caller fails again to enter the requested information, the call is kicked out at step 524 with an appropriate message, and the call is terminated at step 526. On the other hand, after the winner is notified in step 520, the call will be terminated at step 526.

If a voice is not received in step 506, the caller is given another opportunity to properly respond in step 530. If the caller then properly enters the requested information, the call is forwarded to step 532 and back to step 504 which will then route the call along a proper path. On the other hand, if the requested information is still not supplied in step 530, the call is routed to a kickout message in step 540 and a hangup in step 542.

On the other hand, if the call is not identified as being a “winner” in step 486, the call is flagged at step 550 and a non-winner message is played in step 552, with a hangup in step 554. As can be seen in FIG. 9, any non-winner process, process 412, will result in steps 552 and 554.

Returning to special routine step 342, it can be understood from FIG. 9 that entry into this routine generates a prompt at steps 560 and 562 for additional information, such as a second UPC or the like along with an entry prompt, such as digit “3” on a touchtone telephone to enter the requested data. If the caller enters the requested prompt, the call is routed to a data evaluation step 564, which can also be entered via the above-discussed UPC checking process 450. Step 566 compares the entered data with data previously entered by the data gathering entity to determine winners or other data that are entitled to special handling for this routine. The caller is prompted to enter the data associated with this routine and press an entry tone on the telephone at step 568. If the tone is properly entered, the call is forwarded to the above-discussed UPC routine 340 at step 570. On the other hand, if the proper entry process is not completed in step 568, the number of the attempt is checked at step 572. If the attempt is a first attempt (or less then the number determined by a data gathering entity), the caller is given another opportunity to enter the data at step 574. However, if the attempt is a second or higher attempt, the call is routed to a kickout message in step 576, and then the call is terminated in step 578.

Still further, returning to the special handling routine entry point 342, and data entry step 562, if the proper data entry has not been performed, the caller is asked for another data enrty tone at step 580. If the proper data entry step is carried out at step 580, the call is forwared to UPC routine 570 and handled as above discussed. On the other hand, if the proper response is not received in step 580, the call is checked for the attempt number. If the call is a first attempt at this point, the call is returned at step 582 to step 584 so the caller is given another opportunity to enter the data requested in step 560. On the other hand, if the attempt exceeds the permitted number, such as one, the call is routed to step 586 where information is provided and the call terminated at step 588.

It is to be understood that while certain forms of the present invention have been illustrated and described herein, it is not to be limited to the specific forms or arrangement of parts described and shown.

What is claimed and desired to be secured by Letters Patent is as follows:

1. A method of compiling data comprising:
inviting telephone responses to a data-gathering campaign;
inviting Internet responses to a data-gathering campaign;
automatically routing the telephone responses and the Internet responses to a single data bank which is common to both a telephone response path and an Internet response path;
preventing duplicate telephone responses from reaching the single data bank;
preventing duplicate Internet responses from reaching the single data bank; and
using data captured in the single data bank to analyze a campaign.

2. The method defined in claim 1 further including a step of further processing non-duplicate responses.

3. The method defined in claim 2 wherein the step of further analyzing responses includes a step of selecting a response for special attention.

4. The method defined in claim 2 further including a step of merging telephone responses and Internet responses received in the data bank into a single merged data report.

5. The method defined in claim 3 wherein the step of further analyzing responses includes a step of identifying a respondent associated with the selected response.

6. The method defined in claim 5 wherein the step of further analyzing responses includes a step of notifying the identified respondent.

7. The method defined in claim 6 wherein the step of further analyzing responses includes a step of notifying a non-selected respondent that their response has not been selected for special attention.

8. The method defined in claim 7 wherein the telephone response is via a toll-free number.

9. The method defined in claim 1 wherein the step of using the single data base to analyze a campaign includes steps of analyzing respondent profiles and information including name and address.

10. The method defined in claim 6 wherein the step of further analyzing responses includes a step of notifying the respondent via the channel used by the respondent to accept the invitation.

11. The method defined in claim 9 wherein the step of using the single data bank includes capturing cookie information.

12. The method defined in claim 1 further including a step of identifying the number of Internet responses.

13. The method defined in claim 1 wherein the step of preventing duplicate responses includes notifying a respondent associated with a duplicate entry of the prevention step being taken.

14. The method defined in claim 1 wherein the step of further analyzing responses includes a step of capturing HTML and sending HTML to a browser.

15. The method defined in claim 13 further including a step of notifying a respondent associated with a duplicate response when a response from that respondent will be accepted.

16. The method defined in claim 2 wherein the step of further analyzing responses includes a step of obtaining ANI for each response received via a telephone channel.

17. The method defined in claim 7 wherein the step of further analyzing responses includes a step of notifying a non-selected respondent when another response will be accepted from that non-selected respondent.

18. The method defined in claim 1 wherein the step of routing telephone responses includes interactive voice response steps.

19. The method defined in claim 1 wherein the step of routing telephone responses includes automatic number identification steps.

20. The method defined in claim 17 wherein the step of routing Internet responses includes automatic number identification steps.

21. The method defined in claim 1 further including a step of entering a UPC associated with a response into the data base.

21. The method defined in claim 1 further including entering a UPC associated with a response into a single data base.

22. The method defined in claim 21 further including a step of checking the validity of each UPC entered into the single data bank as it is entered and notifying a respondent if the UPC is not valid.
